(19) United States
(12) Patent Application Publication
(10) Pub. No.: US 2012/0082654 A1
(43) Pub. Date: Apr. 5, 2012

(54) Method For Preventing And Controlling Organisms That Infest Aqueous Systems

(76) Inventors: Lucio Panizza, Bologna (IT); Elena Roda, Bologna (IT); Alessandra Stefan, Bologna (IT); Alejandro Hochkoeppler, Bologna (IT)

(21) Appl. No.: 13/261,065

(22) PCT Filed: Jun. 10, 2010
(86) PCT No.: PCT/EP2010/058177

§ 371 Date: Dec. 7, 2011

(30) Foreign Application Priority Data
Jun. 17, 2009 (IT) BO2009A000395

(51) Int. Cl. A01N 37/00; A01P 7/04

(52) U.S. Cl. 424/94.4; 424/94.1; 424/94.6; 424/94.5

(57) ABSTRACT

Method for preventing and controlling organisms that infest aqueous systems in which one or more organic or inorganic compounds capable of releasing gas are present, comprising the step of dispersing on and/or in the aqueous mass a preparation comprising enzymes adapted to catalyze a reaction of the one or more compounds that leads to the formation of gas.

The present invention relates to a method for preventing and controlling organisms that infest aqueous systems.

### BACKGROUND OF THE INVENTION

The struggle against organisms that infest the waters is a problem that has been known and investigated for a long time. The strategy for eliminating undesired organisms is based on the use of molecules that have a direct effect on the targeted organisms, whether they are adults or at the larval stage.

The term prevention is used to mean any method for eliminating and/or reducing the risks derived from the presence of organisms that infest the aqueous systems. More specifically prevention is intended as all the actions aimed at impeding and/or reducing the risk derived from non desired events.

There are different classes of insecticides that are used today, including those that are phospho-organic, chloro-organic and pyrethroid based. All of these chemical compounds are highly effective in eliminating the infesting insects and they act in a direct way on the targeted organisms, but they are also highly toxic; in fact, generally these insecticides, not only persist in the environment, accumulating in the food chain, but they can also be highly toxic for humans.

Within the category of products for the fight against the infesting agents there are also pesticides that regulate growth.

The function of these insecticides is to control the development of the adult insects through the killing of the eggs and/or the larvae of such insects. The use of these larvacides is localized in the environments where the eggs are deposited and develop. The classes of larvacides that are most widely used today are of two types:

1) chemical molecules;

2) bacteria that produce toxins that act on the eggs and/or on the larva.

These two classes of larvacides, like the insecticides described above, have a direct effect on the targeted organism, in that they are absorbed by the eggs and/or by the larvae thus causing their death.

These insecticides are also highly toxic for the environment and for humans. It has been verified, in fact, that the dispersion of these products in open systems has high toxicological and eco-toxicological effects.

In order to control and evaluate the phytopharmaceuticals and the biocides before their introduction on the market, it has been necessary to introduce European laws (Directive 91/414/CEE and Directive 98/8CEE) that, through the imposition of tests evaluating the toxicological and environmental risks of the above mentioned categories of products, have reduced the number of products and/or have limited their use.

For all of these reasons, the development and the introduction on the market of technologies and/or innovative substances directed to control the infestations of undesired insects are highly desirable. Such intention is confirmed also by the possibility of having simplified registration procedures, even in terms of economic costs, that the Directives prescribe for low-risk products.

### SUMMARY OF THE INVENTION

The aim of the present invention is to provide a method for preventing and controlling organisms that infest the aqueous systems which has characteristics of low toxicological and eco-toxicological impact.

This aim and other objects, which will become better apparent hereinafter, are achieved by a method for preventing and controlling organisms that infest aqueous systems in which one or more organic or inorganic compounds capable of releasing gas are present, comprising the step of dispersing on and/or in the aqueous mass a preparation comprising enzymes adapted to catalyze a reaction of said one or more compounds that leads to the formation of gas.

### DESCRIPTION OF THE PREFERRED EMBODIMENTS

Further characteristics and advantages of the invention will become better apparent from the following detailed description of a preferred but non-exclusive embodiment of the method for preventing and controlling the organisms that infest the aqueous systems according to the present invention.

It has been developed a method for preventing and controlling organisms that infest the aqueous systems in which one or more organic or inorganic compounds capable of releasing gas are present, which comprises the step of dispersing on and/or in the aqueous mass a preparation, which can be on its own or dispersed in another medium, comprising enzymes adapted to catalyze a reaction of said one or more compounds that leads to the formation of gas.

The products of the reaction create a continuous effervescence for a certain period of time, obtaining two effects directed to eliminate the infesting organisms:

1) repulsion mechanical effect;

2) biocide effect.

The kinetic movement obtained through the effervescence produced prevents the infesting organisms from depositing the eggs, particularly as regards flying insects. Moreover, the obtained effervescence makes it more difficult for the eggs and/or larva to access the oxygen in the environment. The biocide effect, therefore, is obtained by causing the death of the eggs and/or larvae.

In other words, with the method according to the present invention, the biocide and repulsion effects are advantageously achieved by the products obtained by the reactions biocatalyzed by the enzymatic preparation made of elements that are already present in the environment, thus guaranteeing a low environmental impact and almost non-existent toxicological effects.

Preferably, the method for preventing and controlling the organisms that infest the aqueous systems is characterized by the fact that the enzymatic preparation contains enzymes which are selected from the group consisting of oxidoreductases, hydrolases and lyases.

Preferably, the method for preventing and controlling organisms that infest the aqueous systems is characterized by the fact that the enzymatic preparation contains enzymes that are selected from the lyases group.

In an even more preferable way, the lyases belong to the carbonic anhydrases subclass.

Preferably, the method for preventing and controlling organisms that infest the aqueous systems is characterized by the fact that the enzymatic preparation comprises enzymes in the range 0.0001-30.0% (w/w), even more preferably 0.0001-5% (w/w), and even more preferably 0.0001-0.010% (w/w).

In other words, the enzymatic preparation comprises enzymes in the range between 10 and 500000 U/m², preferably between 100 and 50000 U/m², and more particularly between 500 and 25000 U/m².

In a preferred embodiment, the method for preventing and controlling organisms that infest aqueous systems is characterized by the fact that one or more organic compounds capable of releasing gas present in the aqueous systems are selected from the group of organic compounds having the generic structure R—XO_{z}—R1 where X can be C, N, S, O, P, Br, Cl, I, B, F, I and wherein R, R1 can be independently hydrogen, saturated, unsaturated, ramified or linear hydrocarbon groups. Each R and R1 can independently contain functional groups defined as the generic structure cited above (—XO_{z}).

Furthermore the organic compounds can be sources of H⁺ ions and wherein z=1, 2, 3, 4. Finally, R1 can also not be present. For example, the one or more organic compounds capable of releasing gas that are present in the aqueous systems are typically selected from the group consisting of compounds that contain, in their chemical structures, carboxylic, carbonylic, acetalic, ketalic groups and/or a mixture thereof, functional groups composed of nitrogen, sulfur and potassium bonded to oxygen, and sources of H⁺, and/or a mixture of these compounds.

In a preferred embodiment, the method for preventing and controlling organisms that infest aqueous systems is characterized by the fact that one or more inorganic compounds capable of releasing gas present in the aqueous systems are oxide salts having the generic formula (M)ₓ(XOz)_{y} wherein X═C, N, S, O, P, B, Cl, F, Br, I, H and wherein M is a metallic ion or a cationic entity and wherein X, Y, Z are charges so that the resulting salt has a neutral and balanced charge. Typically they are carbonate salts, inorganic salts of chlorine, sodium, magnesium, sulfur, calcium, potassium, bromine, carbon, strontium, boron, silicon, fluorine, argon, nitrogen, and/or a mixture of these compounds.

In the case that the inorganic compounds were carbonate salts, the gas released would be CO₂, which is eco-compatible, has a low environment impact and a low toxicological risk.

Preferably, the method for preventing and controlling organisms that infest the aqueous systems is characterized by the fact that the enzymatic preparation further comprises buffers selected from the group consisting of borate, phosphate, acetate, citrate, sulfate buffers; in a preferred embodiment the above mentioned enzymatic preparation further comprises:

i) binders for the powder formulation which are selected from the group consisting of lignosulfonates, methylcellulose, carboxymethylcellulose, talc, stearic acid, magnesium and calcium stearates, polysaccharides with acid functions that are salified with magnesium, potassium and calcium, consisting of arabinose, D-galactopyranose, ramnopyranose and D-glucuronic acid; and/or

ii) antioxidants selected from the group consisting of ascorbic acid, a mixture of butylhydroxytoluene, butylhydroxyanisole, and glicole esilenico, 4-hydrobenzoic acid methyl esters, sodium hydrosulfite and bisulfite, tocopherols, alkyl-gallates, 2-phenoxyethanol, sucrose, glucose, dextrose, sugars; and/or

iii) stabilizers selected from the group consisting of citric acid and tartaric acid; and/or

iv) substances that absorb humidity which are selected from the group consisting of glycerol, silica gel, clay, calcium sulfate, magnesium sulfate, sodium thiosulfate, sucrose; and/or

v) sources of gas selected from inorganic salts including carbonate salts, nitrate, nitrite, sulfite, sulfate, phosphite and phosphate; and/or

vi) a mixture of the above mentioned compounds.

Preferably the method according to the present invention further comprises a source of CO₂ in the preparation.

Preferably the method according to the present invention comprises a composition containing a mixture of substances for controlling the pH of the environment in which the product is distributed. This method consists in adding a buffer in order to regulate the pH of the aqueous environment to values at which the activity of the enzyme is at a maximum. The buffer solutions are solutions that act against pH variations through small additions of acids and bases. They are usually solutions of a weak acid and its salt with a strong base or, vice versa, of a weak base and its salt with a strong acid or also of a salt, a weak base and a weak acid of acids and bases that are strongly concentrated.

Buffer solutions are widely used in analytical chemistry and in those processes where it is useful or necessary to stabilize the pH at a desired value. A peculiar characteristic of this type of solution is the buffering power, commonly defined as the amount of strong acid or base to be added to a buffer solution to obtain a unitary pH variation.

Preferably, the method for preventing and controlling organisms that infest the aqueous systems is characterized by the fact that the enzymatic preparation is inserted in a solid and/or liquid and/or aerosol formulation: preferably said solid formulation is selected from the group consisting of powder and/or tablets and/or pellets.

In a preferred embodiment, the method for preventing and controlling organisms that infest the aqueous systems is characterized by the fact that the aqueous systems are areas that are characterized by stagnant water at the surface and/or below ground selected from the group consisting of damp areas, rice fields, stagnant water for farming and other uses, stagnant water contained in vessels, containers for collecting and/or accumulating rainwater, sewage systems, manholes, puddles, cavities of trees.

Examples of formulations according to the present invention are:

product in powder form consisting of:
a. carbonic anhydrases 0.0001%;
b. calcium carbonate 50%;
c. tris sulfate buffer 1%;
d. mixture of butylhydroxytoluene, butylhydroxyanisole and hexylenic glycol 5%;
e. calcium sulfate 2%;
f. talc as needed at 100%;

product in tablet/pellet form consisting of:
a. carbonic anhydrases 1%;
b. stearic acid 5%;
c. ascorbic acid 5%;
d. methylcellulose 20%;
e. calcium sulfate 5%;
f. calcium carbonate 10%;
g. phosphate buffer 5%;
h. talc as needed at 100%;

product in liquid form consisting of:
a. carbonic anhydrases 0.001%;
b. tris sulfate buffer 5%;
c. 4-hydroxybenzoic methyl ester acid 5%;
d. deionized water as needed at 100%.

The quantities of the enzyme indicated in the present description regard the active enzyme and the percentages are weight percentages.

The presence of the activity of the enzyme in an “ideal” system consisting of distilled water and buffer, and in a “real” system consisting of water gathered from the environment, like rainwater, and buffer, was determined in two ways:

1) SPECTROPHOTOMETRIC METHOD: A simple spectrophotometric method takes advantage of the capability of the enzyme to hydrolyze a synthetic substrate (p-nitrophenyl-acetate) producing a product (p-nitrophenol) that has a maximum absorbance at 348 nm. This method allows to study the kinetics of the hydrolysis reaction.

The efficiency of the enzyme, therefore, has been tested in an aqueous environment (rainwater) and it has been shown through the comparison of its activity towards a reference substrate in a standard environment and its activity towards the same substrate in rainwater.

These experiments were carried out using the carbonic anhydrases enzyme from bovine erythrocytes (stock 0.04%, 1000 U/mL). The enzymatic activity has been tested in rainwater and compared with the activity of the same enzyme in a tris sulfate buffer.

In order to perform this, two sample solutions were prepared starting from a stock tris sulfate buffer solution 15 mM (pH 7.6) which is diluted, respectively, with deionized water and rainwater, reaching a concentration of tris sulfate of 10 mM in both cases. The activity of 50 U of enzyme (final concentration 0.002%) has been tested for both samples with the spectrophotmetric method described above.

The results of the enzymatic activity are the following:

Activity after 10 Minutes:

| Buffer + Deionized water | Buffer + Rainwater |
|---|---|
| (−enzyme) | (−enzyme) |
| 0 | 0.00084 |
| Buffer + Deionized water | Buffer + Rainwater |
| (+enzyme) | (+enzyme) |
| 0.0678 | 0.0545 |

Activity after 1 Hour:

| Buffer + Deionized water | Buffer + Rainwater |
|---|---|
| (+enzyme) | (+enzyme) |
| 0.0643 | 0.0498 |

Activity after 15 Hours:

| Buffer + Deionized water | Buffer + Rainwater |
|---|---|
| (−enzyme) | (−enzyme) |
| 0.0518 | 0.0375 |

In terms of percentages compared to the “ideal” solution (no rainwater):

Activity of the enzyme after 10 minutes: 80.38%
Activity of the enzyme after 1 hour: 77.45%
Activity of the enzyme after 15 hours: 72.39%

2) GAS CHROMATOGRAPHIC METHOD: Another method for detecting the enzymatic activity consists in measuring the quantity of CO₂ that is released following the dehydration of the carbonic acid formed in the presence of carbonates. This can be measured through gas chromatography (GC). The reaction of dehydration is favored compared to the inverse reaction in a solution with a pH between 5.5 and 7.5. With this method, therefore, it is possible to determine the enzymatic capability of producing CO₂ by way of the catalysis of the decarboxylation reaction of HCO₃⁻ anions through the measurement of gas produced with the gas chromatography method.

Samples have been prepared according to the methodology described by R. Waygood in Methods in Enzymology (vol. II, Academic Press, 1955). The formation of CO₂ was measured 5 minutes after the addition of the enzyme by injecting in the GC 5004, of the air present in the head space.

It is possible to determine the % of CO₂ present in each sample by calculating the area of the corresponding peaks and using a calibration curve created with known gas percentages.

The carbonic anhydrase from bovine erythrocytes at a final concentration of 0.06% (5000 units) was tested to evaluate the capability of producing CO₂ from rainwater, with the addition of a tris-HCl buffer 0.1M pH 7.2 and carbonate solution.

### Results of the Experiments:

| | Peak Area | Percentage (%) |
|---|---|---|
| Ideal system (−E) | 41561 | 0.62 |
| Rainwater *(−E) | 43846 | 0.65 |
| Ideal system (+E) | 142575 | 2.12 |
| Rainwater *(+E) | 159625 | 2.37 |

E = enzyme
Ideal system = tris-HCl buffer 0.1M pH 7.2 and carbonate solution
*= rainwater with addition of tris-HCl buffer 0.1M pH 7.2 and carbonate solution.

The production of CO₂ that occurred in rainwater wherein the enzyme is present is 3.65 times greater than in rainwater without the enzyme.

The fact that the CO₂ produced from the rainwater system+enzyme is greater than the CO₂ produced from the ideal system+enzyme shows that the enzyme also uses as a substrate the inorganic salts present in this medium.

Two non-exhaustive examples of products compositions and efficiency tests of said products are described hereinafter, which illustrate the object of the invention.

### Examples of Product and Efficiency Tests

### Example 1

### Product Composition

| | CAS | | | Concentration % |
|---|---|---|---|---|
| SAMPLE 1 | substance | Quantity | Udm | of components |
| Sodium bicarbonate | 144-55-8 | 2.2 | gr | 14.18623 |
| Enzyme* (equal to | 9001-03-0 | 0.008 | gr | 0.051586 |
| 20000 U) | | | | |
| Na₂HPO₄ (phosphate | 7558-79-4 | 6.8 | gr | 43.84834 |
| buffer pH 6.8) | | | | |
| KH₂PO₄ (phosphate | 7778-77-0 | 6.5 | gr | 41.91385 |
| buffer pH 6.8) | | | | |
| Total | | 15.508 | gr | 100 |

*carbonic anhydrase from bovine erythrocytes.

### Efficiency Test

The product was tested to verify the efficiency regarding:

1) the reduction of the number of eggs deposited

2) the reduction of the number of eggs opened as an adult

3) other factors limiting the proliferation of the mosquitoes.

The tests were conducted in a cage protected by ventilated netting in which the beakers that acted as a reproduction of stagnant water were placed. The beakers contained 800 mL of water and the surface area available for depositing eggs is 190 cm².

The mosquitoes were fed with blood in order to promote egg deposition. They were left to get used to the environment for 1 day, after which time the product was poured in the beaker. Subsequent additions of bicarbonate were made every 24 hours.

Duplicate tests were done and each duplicate was verified with a control beaker in which the product was not added.

### Results at 3 Days

| | Eggs deposited | Dead mosquitoes |
|---|---|---|
| Product | 200 | 11 |
| Control | 3000 | 2 |

Reduction in number of eggs deposited→93%
Increase in mosquito mortality→5.5 times

### Results at 7 Days

| | Number of larvae present |
|---|---|
| Product | 0 |
| Control | 2500 |

### Results at 23 Days

| | Number of adult mosquitoes |
|---|---|
| | formed from the larvae |
| Product | 0 |
| Control | 2200 |

### Example 2

### Product Composition

| | CAS | | | Concentration % |
|---|---|---|---|---|
| SAMPLE 2 | substance | Quantity | | of components |
| Carbonate | 471-34-1 | 40 | gr | 75.03564 |
| Enzyme* | 9001-03-0 | 0.008 | gr | 0.015007 |
| Na₂HPO₄ (phosphate | 7558-79-4 | 6.8 | gr | 12.75606 |
| buffer pH 6.8) | | | | |
| KH₂PO₄ (phosphate | 7778-77-0 | 6.5 | gr | 12.19329 |
| buffer pH 6.8) | | | | |
| Total | | 53.308 | gr | 100 |

*= carbonic anhydrase from bovine erythrocytes.

### Efficiency Test

The product was tested to verify the efficiency regarding:

1) the reduction of the number of eggs deposited

2) the reduction of the number of eggs opened as an adult

3) other factors limiting the proliferation of the mosquitoes.

The tests were conducted in a cage protected by ventilated netting in which the beakers that acted as a reproduction of stagnant water were placed. The beakers contained 800 mL of water and the surface area available for depositing eggs is 190 cm².

The mosquitoes were fed with blood in order to promote egg deposition. They were left to get used to the environment for 1 day, after which time the product was poured in the beaker.

Duplicate tests were done and each duplicate was verified with a control beaker in which the product was not added.

### Results at 3 Days

| | Eggs deposited | Dead mosquitoes |
|---|---|---|
| Product | 100 | 15 |
| Control | 2900 | 2 |

Reduction in number of eggs deposited→96.56%
Increase in mosquito mortality→7.5 times

### Results at 7 Days

| | Number of larvae present |
|---|---|
| Product | 0 |
| Control | 2000 |

### Results at 23 Days

| | Number of adult mosquitoes |
|---|---|
| | formed from the larvae |
| Product | 0 |
| Control | 2100 |

The disclosures in Italian Patent Application No. B02009A000395 from which this application claims priority are incorporated herein by reference.

1-15. (canceled)

16. A method for preventing and controlling organisms that infest aqueous systems in which one or more organic or inorganic compounds capable of releasing gases are present, comprising the step of dispersing on and/or in the aqueous mass a preparation comprising enzymes adapted to catalyze a reaction of said one or more compounds that leads to the formation of gases.

17. The method according to claim 16, wherein the enzyme preparation comprises enzymes selected from the group consisting of oxidoreductases, hydrolases and lyases.

18. The method according to claim 17, wherein the enzyme preparation comprises enzymes selected from the group of lyases.

19. The method according to claim 18, wherein the lyases belong to the subclass of carbonic anhydrases.

20. The method according to claim 16, wherein the enzyme preparation comprises enzymes in the range 0.0001-30.0% (w/w).

21. The method according to claim 20, wherein the enzyme preparation comprises enzymes in the range 0.0001-5.00% (w/w), preferably 0.0001-0.010% (w/w).

22. The method according to claim 16, wherein said one or more organic compounds capable of releasing gases present in aqueous systems are selected from the group of organic compounds having the generic structure R—XO_{z}—R1, wherein:
i) X is C, N, S, O, P, Br, Cl, I, B, F or I;
ii) R is selected from the group consisting of hydrogen, saturated, unsaturated, ramified or linear hydrocarbon groups, and may independently contain functional groups defined as the generic structure cited above (—XOᵣ—);
iii) R1 is absent, or is selected from the group consisting of hydrogen, saturated, unsaturated, ramified or linear hydrocarbon groups, and may independently contain functional groups defined as the generic structure cited above (—XO_{z}—);
iv) the organic compounds are sources of H⁺ ions and z=1, 2, 3, 4.

23. The method according to claim 22, wherein said one or more organic compounds capable of releasing gases present in aqueous systems are selected from the group consisting of compounds that contain, in their chemical structure, carboxylic, carbonylic, acetalic, ketalic groups and/or a mixture thereof, functional groups composed of nitrogen, sulfur and potassium bonded to oxygen, and sources of H⁺, and/or a mixture of these compounds.

24. The method according to claim 16, wherein said one or more inorganic compounds capable of releasing gases present in aqueous systems are oxide salts having the generic formula (M)ₓ(XOz)_{y}, wherein X is C, N, S, O, P, H, B, Cl, F, Br or I and where M is a metallic ion or a cationic entity and wherein X, Y, Z are charges which result in the salt having a neutral and balanced charge.

25. The method according to claim 24, wherein said one or more inorganic compounds capable of releasing gases present in aqueous systems are selected from the group consisting of carbonate salts, inorganic salts of chlorine, sodium, magnesium, sulfur, calcium, potassium, bromine, carbon, strontium, boron, silicon, fluorine, argon, nitrogen and/or a mixture of said compounds.

26. The method according to claim 16, wherein the preparation further comprises a source of CO₂.

27. The method according to claim 16, wherein the composition comprises a mixture of substances for controlling the pH of the environment in which the product is distributed.

28. The method according to claim 16, wherein the enzyme preparation is selected from the group consisting of a solid and/or liquid and/or aerosol formulation.

29. The method according to claim 28, wherein the solid formulation is selected from the group consisting of powder and/or tablets and/or pellets.

30. The method according to claim 16, wherein the aqueous systems are selected from the group consisting of damp areas, rice fields, stagnant water for farming and other uses, stagnant water contained in vessels, containers for collecting and/or accumulating rainwater, sewage systems, manholes, puddles, cavities of trees.
